(19) United States
(12) Patent Application Publication
(10) Pub. No.: US 2005/0212408 A1
(43) Pub. Date: Sep. 29, 2005

(54) Drive unit for light-emitting display panel, and electronic device mounted therewith

(75) Inventors: Takayoshi Yoshida, Yonezawa-shi (JP); Isamu Ohshita, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/088,974

(22) Filed: Mar. 24, 2005

(30) Foreign Application Priority Data
Mar. 29, 2004 (JP) 2004-95259

(51) Int. Cl. H01J 1/62

(52) U.S. Cl. 313/503

(57) ABSTRACT

A voltage from a constant voltage source for a voltage of V1 is configured to be supplied to an anode line drive circuit 2. Then, a current larger than that, by which the current image is displayed, is supplied from the constant voltage source for a voltage of V1 to EL elements E11 through Enm by connecting all of drive switches Sa1 through Sam in the anode line drive circuit 2 to the side of the constant voltage source for a voltage of V1, and by connecting all of scanning switches Sk1 through Skm in a cathode-line scanning circuit 3 to the side of the ground potential GND. A leak phenomenon generated in an organic EL element can be rehabilitated, or generation of the leak phenomenon can be prevented by such a large current supplied on a regular basis.

### BACKGROUND OF THE INVENTION

1. Field of the Invention

This invention relates to a drive unit which drives light-emitting of a display panel using, for example, organic EL (electroluminescent) elements as light-emitting elements, and, especially, to a drive unit which can self-repair (rehabilitate) a light-emitting element arranged on a display panel and to an electronic device mounted therewith.

2. Description of the Related Art

Development of a display unit using a display panel with a configuration in which light-emitting elements are arranged in a matrix has been widely promoted, and organic EL elements using, for example, an organic material for a light-emitting layer have been noticed as light-emitting elements used for such a display panel. The background is that the elements which are adequate for practical use and have higher efficiency and longer life time have been realized by using an organic compound, which can be expected to have good light-emitting characteristics, for the light-emitting layer of the element.

The above-described organic EL element has a configuration in which a transparent electrode forming an anode on a transparent substrate of, for example, glass, a light-emitting layer including an organic material, and a cathode formed by, for example, a metal electrode are laminated one by one. According to the above laminated structure, the organic EL element can be electrically replaced by a configuration comprising a light-emitting element which has a diodecharacteristic, and a parasitic capacitance compound which is connected to the element in parallel. Accordingly, the organic EL element is considered to be a capacity-type light-emitting element.

When a light-emitting drive voltage is applied to the organic EL element, charges equivalent to the electric capacity of the element concerned, in the first place, flows into an electrode as a displacement current and are accumulated. Successively, when a predetermined voltage (light-emitting threshold voltage=Vth) unique for the element is exceeded, a current begins to flow from an electrode (the side of an anode of the diode element) to an organic layer forming the light-emitting layer and light is emitted with an intensity in proportion to the current, according to a thought.

A passive matrix type display panel (refer to, for example, Japanese Patent Publication No. 2003-288053 with a configuration in which the EL elements are arranged in a matrix at points of intersections between data lines and scanning lines both of which are intersecting perpendicularly to one another, and an active matrix type display panel (refer to, for example, Japanese Patent Publication No. 2003-316315) in which active elements comprising a thin film transistor (TFT) are added to each of the EL elements arranged in a matrix have been proposed as a display panel using such an organic EL element.

The former passive matrix type display panel has a feature that a display can be obtained by a rather simple configuration. On the other hand, the latter active matrix type display panel consumes lower electric power in comparison with the former passive matrix type display panel, and has a feature such as less cross talk between pixels. Especially, the latter active matrix type display panel is more suitable for a high-resolution display forming a large screen.

However, the above-described EL element has a problem that defects in deposition and the like generates leakage currents (hereinafter, also called leaks) between the anode and the cathode to cause a problem of light-emitting failure. The reason is considered to be that locations with a thin light-emitting layer are of lower electric resistance than other locations to cause a state in which currents driving light-emitting of the EL elements are concentrated on the locations with a thin light-emitting layer, and, as a result, driving currents flowing in other normal light-emitting layers are reduced to cause reduced light-emitting brightness. The concentrated currents caused on defected locations in deposition in the light-emitting layer have an influence on other EL elements arranged on the display panel in a matrix to display an undesired image on the display.

The above-described leaks are generated in various ways, based on different reasons, and can be roughly classified into the following three modes according to their generated ways: According to a first leak mode, there are leaks from the start of manufacturing, and self-repairing (rehabilitation) can be realized by the after-described aging and the like; according to a second leak mode, there are no leaks to be found at the start of manufacturing, but leaks are generated later; and according to a third leak mode, there are leaks at the start of manufacturing, but self-repairing cannot be realized even by later aging.

A main structural reason that there are generated the above-described first mode leaks in an EL element is that defects in deposition and the like during manufacturing steps causes a short-circuit state of a part of an anode and that of a cathode through a part of a light-emitting layer. As electric resistance is comparatively large when the short-circuited portions are thick, leaks can be eliminated by heating the portions through passing currents in the portions by aging and the like. The above process is self-repairing.

The inventors of the present invention have learned that possibility of self-repairing is increased by passing the above-described currents in the EL element in the forward and backward directions, and the larger current value at this time causes the more increased possibility of self repairing. Even when a part of defects in deposition is eliminated by self-repairing based on the above-described aging, and there are no leaks to be found, there are some cases in which leaks are later generated again in a similar manner to that of the above-described second leak mode.

For execution of the above-described aging, a method by which a state, in which all the EL elements arranged on a display panel are lighted, is kept for a certain period of time is preferably applied. In this case, in a passive drive type display panel a non-lighting scanning period is preferably provided in one frame (or one sub-frame) period. And, it is preferable during the non-lighting scanning period to make an opportunity to apply a reverse bias voltage from the side of scanning lines to all the EL elements arranged on the display panel.

Moreover, it is also preferable in an active drive type display panel to make an opportunity to simultaneously apply the reverse bias voltage in one frame (or one sub-frame) period to all the EL elements arranged on the display panel in a similar manner to that of the passive drivetype display panel. Thereby, it is possible to effectively rehabilitate an EL element with the above-described leaks.

Then, leaks according to the above-described second leak mode mean a case in which electrodes are in close vicinity to one another at the manufacturing steps so that a short-circuit state is not caused, and a short-circuit state of an EL element is caused by changes in electrodes or light-emitting layers over time and the like after the market introduction. When an electronic device mounted with such a display panel has leaks after a user gets possession of the electronic device, there may be caused not only a case in which the display quality is remarkably deteriorated for the user, but also a case in which a serious accident is generated when the electronic device is used as a medical device, or when the electronic device is adopted for a measurement unit in an aircraft and the like.

Furthermore, leaks according to the above-described mode means a case in which short-circuited portions of electrodes forming an EL element are relatively thick and it is difficult to realize self-repairing by applying currents to the EL elements by use of the above-described aging. A method to forcefully eliminate the short-circuited portions can be adopted, using, for example, laser beams. But, even when such rehabilitation is performed, there may be some cases in which new leaks are generated in a similar manner to that of the second leak mode after a user gets possession of an electronic device mounted with a display panel.

### SUMMARY OF THE INVENTION

This invention has been made, noting the above-described problems of leaks caused in a light-emitting element, and, especially, a technical object of the invention is to provide a drive unit for a display panel and an electronic device mounted with the drive unit, wherein effective self-repairing can be realized when leaks according to the above-described first and second leak modes are generated in an EL element.

As described as the first aspect of the present invention, a preferable embodiment of a drive unit according to this invention which has been made in order to solve the above-described problems is a drive unit for a light-emitting display panel with a pixel configuration including at least a plurality of scanning lines and a plurality of data lines which are intersecting with each other, and self-light-emitting elements with a diode characteristic, each of which is arranged at each intersecting point of each of the scanning lines and each of the data lines, and is characterized in that the drive unit has a configuration in which a first current can be supplied from the side of the anode terminal in each self-light-emitting element concerned, and a second current larger than the first current can be supplied to the self-light-emitting element in order to drive the self-light-emitting element for lighting.

Moreover, as described as the second aspect of the present invention, another preferable embodiment of a drive unit according to this invention which has been made in order to solve the above-described problems is a drive unit for a light-emitting display panel which has a pixel configuration including at least a plurality of scanning lines and a plurality of data lines which are intersecting with each other, and self-light-emitting elements with a diode characteristic, each of which is arranged at each intersecting point of each of the scanning lines and each of the data lines, and has a configuration in which, in order to drive the self-light-emitting element for lighting, a reverse-bias voltage in the backward direction, which is opposed to the forward direction, can be applied to the self-light-emitting element, and is characterized in that the reverse-bias voltage has a first voltage and a second voltage larger than the first voltage.

### BRIEF DESCRIPTION OF THE DRAWINGS

FIG. 1 is a view showing a circuit structure of a drive unit according to a first embodiment of the present invention;

FIG. 2 is a view showing a circuit structure of a drive unit according to a second embodiment of the invention;

FIG. 3 is a view showing a circuit structure of a drive unit according to a third embodiment of the invention;

FIG. 4 is a view showing a circuit structure of a drive unit according to a fourth embodiment of the invention;

FIG. 5A is a view explaining an operation according to the circuit structure shown in FIG. 4;

FIG. 5B is a view explaining another operation according to the circuit structure shown in FIG. 4;

FIG. 6 is a view showing a circuit structure of a drive unit according to a fifth embodiment of the invention;

FIG. 7 is a view showing a circuit structure of a drive unit according to a sixth embodiment of the invention;

FIG. 8 is a view showing a circuit structure of a drive unit according to a seventh embodiment of the invention;

FIG. 9 is a view showing a circuit structure of a drive unit according to a eighth embodiment of the invention;

FIG. 10 is a view showing a circuit structure of a drive unit according to a ninth embodiment of the invention;

FIG. 11 is a view showing a circuit structure of a drive unit according to a tenth embodiment of the invention;

FIG. 12 is a view showing a circuit structure of a drive unit according to a eleventh embodiment of the invention;

FIG. 13 is a flow chart showing a preferable operation flow by which a second self-repairing mode is executed; and

FIG. 14 is a block diagram showing a configuration example in which the invention is applied to a personal digital assistance.

### DESCRIPTION OF PREFERRED EMBODIMENTS

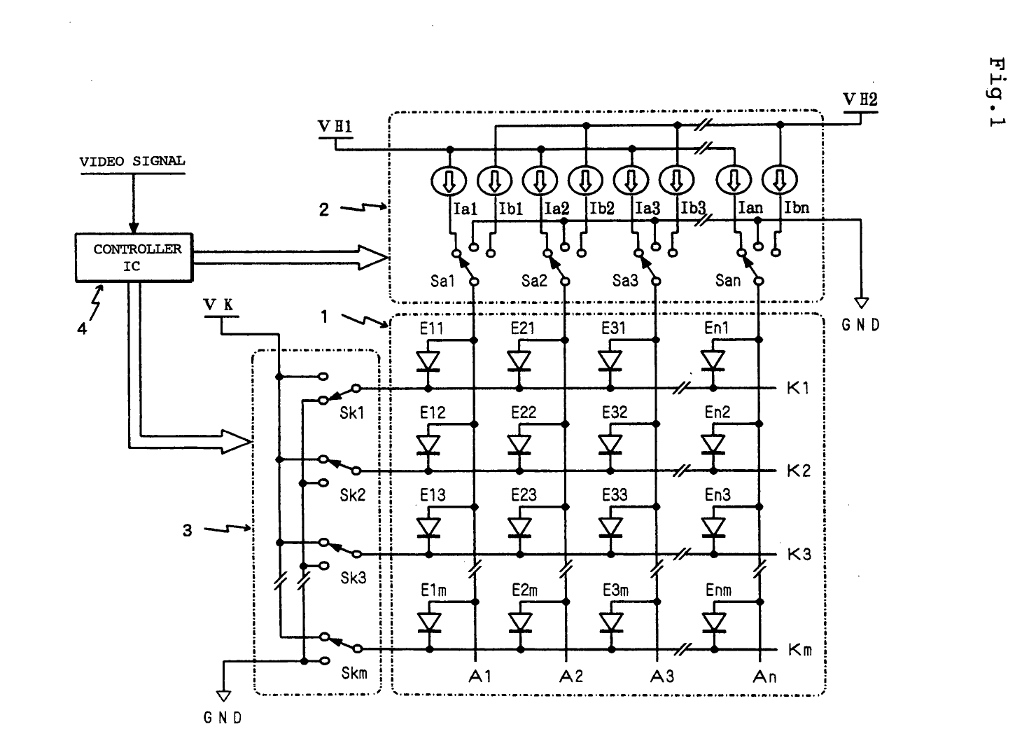

Hereinafter, a drive unit for a light-emitting display panel according to this invention will be explained, based on embodiments shown in drawings. FIG. 1 shows a first embodiment, and an example of a passive matrix type display panel and that of a driving circuit for the display panel are shown in FIG. 1. Here, the embodiment shown in FIG. 1 is based on the first and second aspects of the present invention. There are two methods as a passive matrix drive method according to which an organic EL element is driven: that is, a cathode-line scanning and anode-line drive method; and an anode-line scanning and cathode-line drive method. A configuration shown in FIG. 1 is the former one, that is, the cathode-line scanning and anode-line drive method.

That is, a display panel 1 has a configuration in which n pieces of data lines (hereinafter, also called anode-lines) A1 through An are arranged in the vertical direction; m pieces of scanning lines (hereinafter, also called cathode lines) K1 through Km are arranged in the horizontal direction; and organic EL elements E11 through Enm, represented with symbol marks of a diode, are arranged at each intersecting place (n×m points in total).

And, in each EL element E11 through Enm forming a pixel, one end (an anode terminal of an equivalent diode to the EL element) is connected to an anode line, and the other one (a cathode terminal of the equivalent diode to the EL element) is done to a cathode line, according to points of intersections between the anode-lines A1 through An in the vertical direction and the cathode lines K1 through Km in the horizontal direction. Moreover, the anode-lines A1 through An are connected to an anode-line drive circuit 2, and the cathode lines K1 through Km are done to a cathode-line scanning circuit 3 for each driving.

The above-described anode-line drive circuit 2 has a configuration in which constant current sources Ia1 through Ian which are operated by driving voltages from a driving voltage source for a voltage of VH1, constant current sources Ib1 through Ibn which are operated by driving voltages from a driving voltage source for a voltage of VH2, and drive switches Sa1 through Sam are provided. Then, first currents from the constant current sources Ia1 through Ian are configured to be supplied as a lighting driving current to each of the EL elements E11 through Enm arranged corresponding to the cathode lines by connecting the drive switches Sa1 through Sam to the sides of the constant current sources Ia1 through Ian.

Moreover, second currents from the constant current sources Ib1 through Ibn are configured to be supplied in the forward direction to each of the EL elements E11 through Enm by connecting the above-described drive switches Sa1 through Sam to the sides of the above-described constant current sources Ib1 through Ibn. The values of the second currents supplied from the above-described constant current sources Ib1 through Ibn are set to be larger than the values of the above-described first currents as lighting driving currents of the EL elements in order to realize self-repairing of the EL elements, though will be explained in detail later. Moreover, the above-described drive switches Sa1 through Sam are also configured to be connected to the ground potential GND as the reference potential point in this embodiment.

On the other hand, the above-described cathode-line scanning circuit 3 includes scanning switches Sk1 through Skm, corresponding to the cathode-lines K1 through Km, respectively, and the scanning switches Sk1 through Skm operate for connection so that either of a voltage supplied from a reverse-bias-voltage source for a voltage of VK to prevent the EL elements from cross-talk light-emitting, or the ground potential GND as a reference potential point is supplied to the corresponding cathode lines.

Here, a control signal is supplied from a controller IC 4 including a CPU to the above-described anode-line drive circuit 2 through a control bus, and another control signal is done from the controller IC 4 to the above-described cathode-line scanning circuit 3 through the control bus. Then, according to video signals for an image to be displayed, the above-described scanning switches Sk1 through Skm and the above-described drive switches Sa1 through Sam are switched. Thereby, according to the video signals, any one of the constant current sources Ia1 through Ian is connected to a desired anode line one by one while setting the cathode scanning lines at the ground potential with a predetermined cycle. Accordingly, light emitting of each of the above-described EL elements is selectively executed, and an image according to the above-described video signals is displayed on the display panel 1.

Here, in a state shown in FIG. 1, the first cathode line K1 is set at the ground potential to be in a scanning state. At this time, the reverse bias voltage is applied from the above-described reverse bias voltage source for a voltage of VK to the cathode lines K2 through Km in non-scanning state. Here, assuming that a forward voltage of an EL element which is scanned for light emitting is Vf, each of the potential is set so that the following relation can be obtained: [(FORWARD VOLTAGE Vf)−(REVERSE BIAS VOLTAGE VK)]<(LIGHT-EMITTING THRESHOLD VOLTAGE Vth). Accordingly, a voltage equal to or lower than the light-emitting threshold voltage Vth is applied to each of EL elements connected to an intersecting point of an anode line, which is driven, and a cathode line, which is not selected for scanning, and crosstalk light-emitting of each the EL elements is prevented.

On the other hand, in the embodiment shown in FIG. 1, the above-described second currents can be supplied in the forward direction to corresponding one of the EL elements E11 through Enm, respectively, by connecting all the drive switches Sa1 through Sam in the anode-line drive circuit 2 to the side of the corresponding source of the constant current sources Ib1 through Ibn, and by connecting all the scanning switches Sk1 through Skm in the cathode-line scanning circuit 3 to the GND side. Thereby, all the EL elements E11 through Enm are put into a light-emitting state in which an image with higher brightness than that generated by the first currents is displayed. Here, it is assumed that the above process is called a first self-repairing mode.

When the above-described first self-repairing mode is executed, a short-circuited portion in an EL element can be eliminated for rehabilitation of the EL element by passing a comparatively large second current in the short-circuited portion which exists in a part between the anode and the cathode of the EL element. In order to repair a leak of the first leak mode which has existed from the start of manufacturing, it is effective, as already explained, to execute this first self-repairing mode during aging at the start of manufacturing.

Moreover, after the market introduction of a light-emitting module including a display panel and a drive unit according to the present invention, it is possible to repair leaks of the above-described second leak mode, or to prevent the generation of the leaks when the first self-repairing mode is executed on a regular basis, using a timer provided in an electronic device comprising the above-described light-emitting module, as will explained in detail later.

Here, the embodiment shown in FIG. 1 has a configuration in which the constant current sources Ib1 through Ibn are provided in order to supply the above-described second currents in the forward direction to corresponding one of the EL elements E11 through Enm. Moreover, there may be applied another configuration in which the output current values of each of the constant current sources Ia1 through Ian are variable in order to supply the first currents to the above-described constant current elements E11 through Enm, and the first self-repairing mode is executed by supplying the above-described second currents from the constant current sources Ia1 through Ian to corresponding one of the EL elements E11 through Enm. Thereby, the third aspect of the present invention can be realized to simplify the configuration.

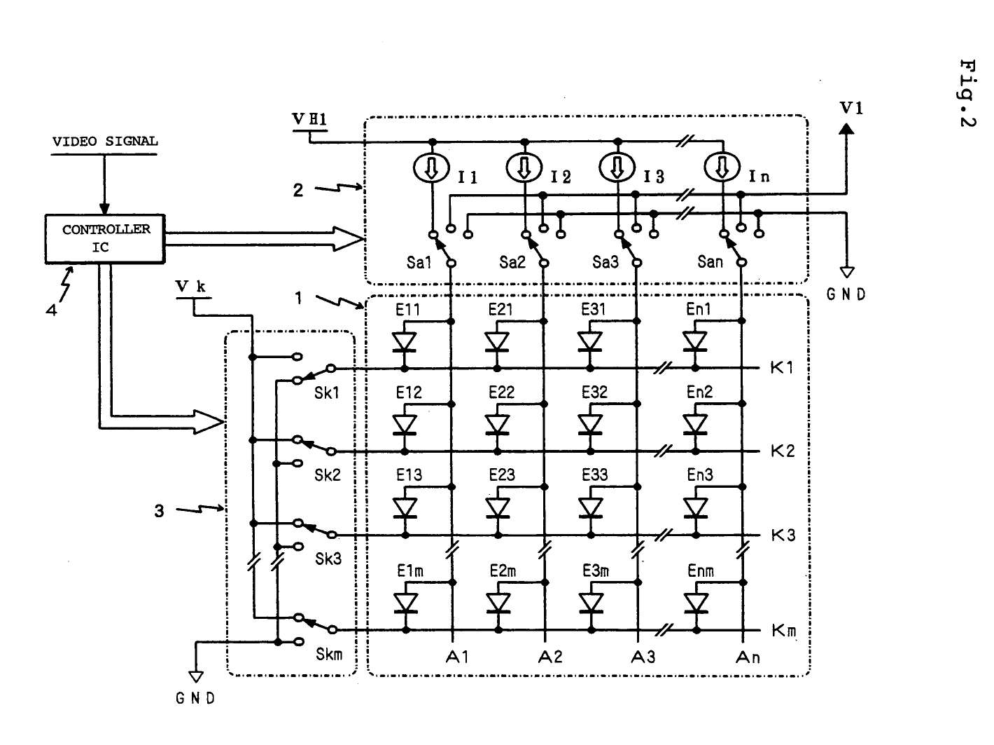

FIG. 2 shows a second embodiment according to the present invention, and an example of a passive matrix type display panel and that of a driving circuit for the display panel are shown in FIG. 2 in a similar manner to that of FIG. 1. In FIG. 2, parts, which are similar to those previously explained in FIG. 1 with regard to their functions, are denoted by the same reference numbers as those in FIG. 1, and common detailed description will be eliminated. Here, the embodiment shown in FIG. 2 is based on the fourth aspect of the invention.

In the embodiment shown in FIG. 2, second currents used for execution of the above-described first self-repairing mode are configured to be supplied from constant voltage sources. That is, a voltage from a constant voltage source for a voltage of V1, instead of the constant current sources Ib1 through Ibn shown in FIG. 1, is used in the configuration shown in FIG. 2. According to this configuration, scanning switches Sk1 through Skm are switched to the ground potential GND for scanning one by one according to video signals for an image to be displayed, and, in synchronization with the switching, drive switches Sa1 through Sam are connected to any one of constant current sources I1 through In. Accordingly, an image based on the above-described video signals is displayed on a display panel 1 by selective light-emitting of the above-described EL element E11 through Enm by the above-described first currents.

On the other hand, the above-described second currents are supplied from the constant voltage source for a voltage of V1 to the EL elements E11 through Enm by connecting all the drive switches Sa1 through Sam in an anode-line drive circuit 2 to the side of the constant voltage, source for a voltage of V1, and by connecting all of scanning switches Sk1 through Skm in a cathode-line scanning circuit 3 to the side of the ground GND. Thereby, all the EL elements E11 through Enm are put into a light-emitting state in which an image with higher brightness than that generated by the first currents is displayed. The above-described process in the present embodiment is called a first self-repairing mode, and the first self-repairing mode can be used, as will be described later, to repair leaks of the first and second leak modes, or to prevent the generation of the leaks.

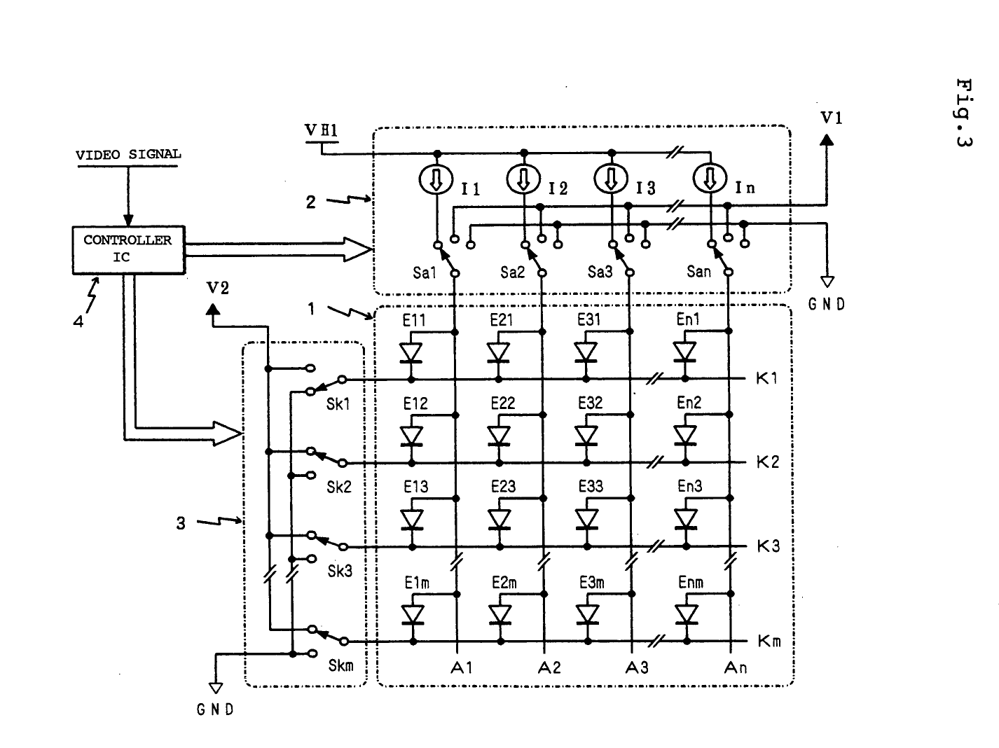

FIG. 3 shows a third embodiment according to the present invention, and an example of a passive matrix type display panel and that of a driving circuit for the display panel are shown in FIG. 3 in a similar manner to those of FIGS. 1 and 2. In FIG. 3, parts, which are similar to those previously explained in FIGS. 1 and 2 with regard to their functions, are denoted by the same reference numbers as those in FIGS. 1 and 2, and common detailed description will be eliminated. Here, the embodiment shown in FIG. 3 is based on the fifth aspect of the invention.

The embodiment shown in FIG. 3 has a feature that a constant voltage source by which reverse-bias voltages can be applied to EL elements E11 through Enm arranged in a display panel 1 is further provided in addition to the configuration of the embodiment shown in FIG. 2. That is, the configuration shown in FIG. 3 has a configuration in which constant voltages V2 are supplied to a cathode-line scanning circuit 3 in the configuration shown in FIG. 3. Moreover, in the configuration shown in FIG. 3, constant voltages V1 are configured to be supplied to an anode line drive circuit 2, and the values of the above-described constant voltages are configured to meet a relation: V1≦V2. Here, the voltage V1 does not necessarily have the same relation with regard to the level as that of the voltage V1 shown in FIG. 2. Hereinafter, the relation for the voltage V1 will be independently defined for each embodiment.

According to the configuration shown in FIG. 3, the reverse-bias voltages can be applied to the EL elements E11 through Enm by connecting all of drive switches Sa1 through Sam in the above-described anode line drive circuit 2 to the side of the constant voltage source for a voltage of V1, and by connecting all of scanning switches Sk1 through Skm in the cathode-line scanning circuit 3 to the side of the constant voltage source for a voltage of V2.

Therefore, according to the configuration shown in FIG. 3, the first self-repairing mode can be selected in a similar manner to that of FIG. 2 in order to supply a second current to the EL elements E11 through Enm, and the reverse-bias voltages can be simultaneously applied to each of the EL element E11 through Enm, respectively. Thereby, it is possible to repair leaks of the after-described first and second leak modes, or to prevent the generation of the leaks.

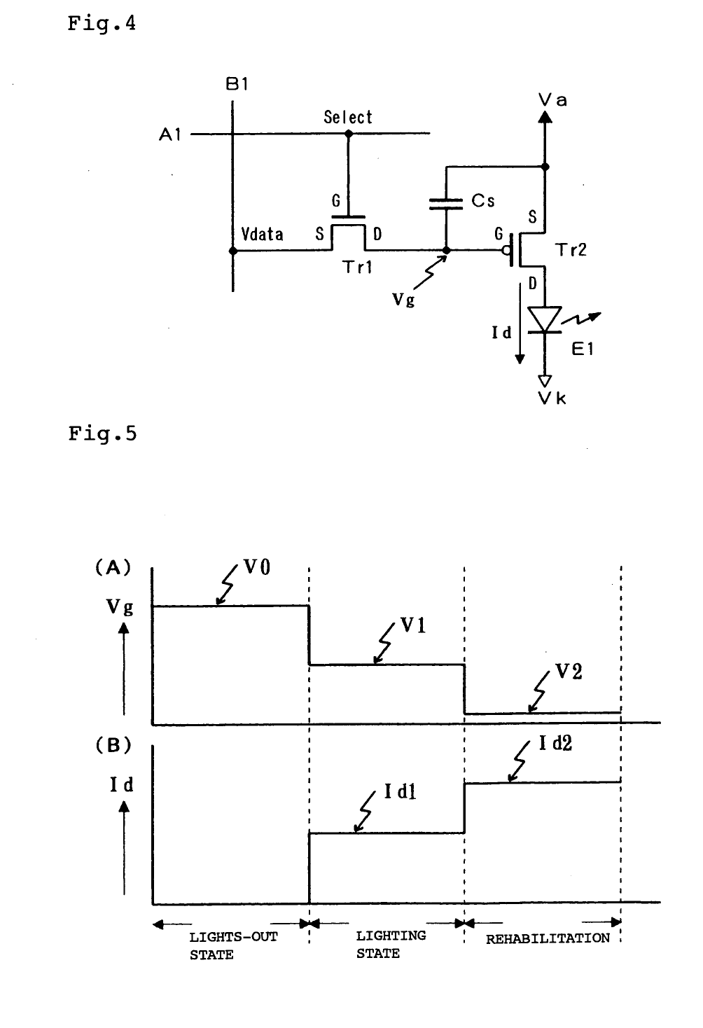

FIGS. 4 and 5 show a fourth embodiment according to the present invention, and an example in which the invention is applied in an active drive type display panel is shown in the drawings. Here, the embodiment shown in FIGS. 4 and 5 is mainly based on the sixth aspect of the invention. FIG. 4 shows a configuration for a pixel formed on the display panel, and the pixel configuration shows a most basic pixel configuration in which one organic EL element which is called a conductance controlled one including two TFTs is used for a light-emitting element.

As shown in FIG. 4, a gate G in a scanning selection transistor Tr1 including a n-channel type TFT is connected to a scanning signal line A1 arranged on the display panel, and the source S of the transistor is connected to a data signal line B1. Moreover, the drain D of the scanning selection transistor Tr1 is connected to the gate G of a light-emitting drive transistor including a p-channel type TFT, and is simultaneously connected to one terminal of a capacitor Cs for charge retention.

Moreover, the source S of the light-emitting drive transistor Tr2 is connected to the other terminal of the above-described capacitor Cs, and is simultaneously connected to a power supply line Va. Furthermore, the anode of the organic EL element E1 as a light-emitting element is connected to the drain D of the light-emitting drive transistor Tr2, and the cathode of the EL element E1 concerned is simultaneously connected to Vk, for example, the ground potential GND as a reference point. Then, a number of light-emitting display pixels with the above-described configuration are horizontally and vertically arranged on the display panel in a matrix to form an active matrix type display panel.

When a scanning signal (Select) is supplied from a not-shown scanning driver to the gate of the scanning selection transistor Tr1 through the scanning signal line A1 in the configuration shown in FIG. 4, the scanning selection transistor Tr1 is put into an ON state. At this time, a data signal (Vdata) is supplied from a not-shown data driver to the source of the scanning selection transistor Tr1 through the data signal line B1. Accordingly, the transistor Tr1 passes a current, which is corresponding to the data signal (Vdata) supplied to the source, from the source to the drain.

Thereby, the above-described capacitor Cs is charged to a voltage V1 corresponding to the data signal (Vdata) in the ON period of the scanning selection transistor Tr1, and the voltage is supplied to the gate of the light-emitting drive transistor Tr2. Accordingly, the light-emitting drive transistor Tr2 passes a current (first current) based on the gate voltage V1 and the source voltage in the EL element E1 as a drain current Id1 to drive lighting of the EL element.

On the other hand, the scanning selection transistor Tr1 is put into a so-called CUT-OFF state when the supply of the scanning signal (Select) to the gate of the scanning selection transistor Tr1 is stopped. At this time, the drain of the transistor concerned is put into an open state, but the potential of the light-emitting drive transistor Tr2 is kept at the gate potential by charges accumulated in the capacitor Cs. Accordingly, the driving current of the drive transistor Tr2 is maintained till the subsequent scanning. Thereby, the lighting of the EL element E1 is also kept.

The display panel provided with the light-emitting pixels with the above-described configuration has a configuration in which the gate voltage V2 lower than the gate voltage V1 of the above-described transistor Tr2 is supplied as the data signal (Vdata) from the not-shown data driver. Thereby, the lower gate voltage V2 is applied to the gate of the light-emitting drive transistor Tr2, and the transistor Tr2 is configured to supply the current (second current) larger than the light-emitting drive current (first current) caused by an image signal to the EL element E1.

FIG. 5 explains the above processing, and the gate potential Vg of the transistor Tr2 is shown in FIG. 5A. The drain current Id of the transistor Tr2 is shown in FIG. 5B. As the above-described transistor Tr2 includes a p-channel type TFT, the drain current Id does not flow in a state of V0 in which the gate potential Vg is high, and the EL element E1 is put into a lights-out state. Moreover, the first current Id1 flows as the drain current Id when the gate potential Vg of the transistor Tr2 is set at the above-described V1. Thereby, light-emitting of the EL element E1 is realized according to the image signal.

Furthermore, a current (second current) larger than the light-emitting drive current (first current=Id1) flows as the drain current Id2 when the gate potential Vg of the transistor Tr2 is set lower than the above-described V1. Thereby, the EL element E1 is put into a light-emitting state in which an image with higher brightness than that generated by the first current is displayed, and repairing (rehabilitation), which has been already described, is executed. The above-described process is called the first self-repairing mode in the present embodiment, and the first self-repairing mode can be used, as will be described later, to repair leaks of the first and second leak modes, or to effectively prevent the generation of the leaks.

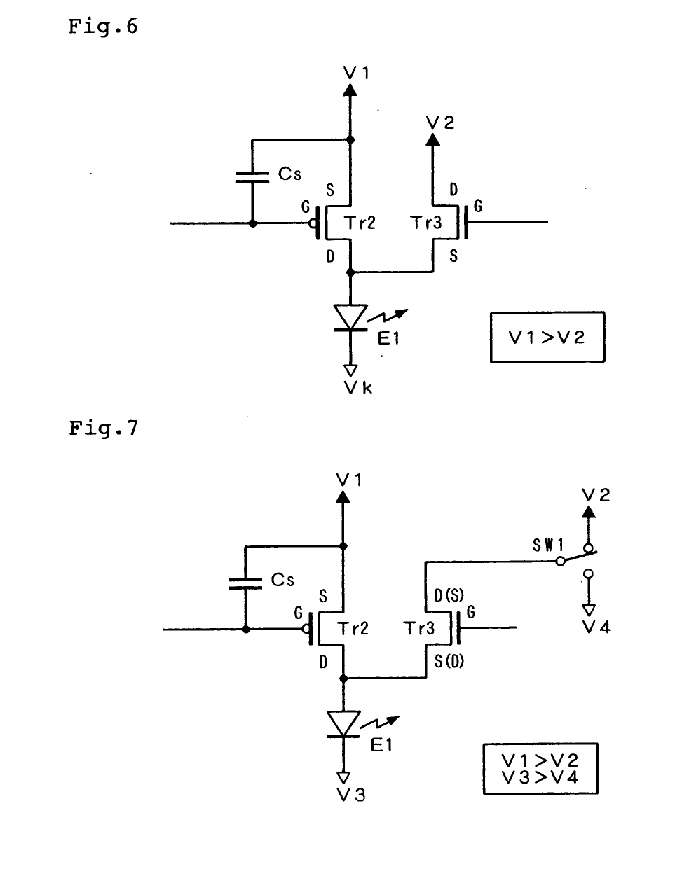

FIG. 6 shows a fifth embodiment according to the present invention, and an example in which the invention is also applied in an active drive type display panel is also shown in the drawing. Here, the embodiment shown in FIG. 6 is mainly based on the seventh aspect of the invention. And, FIG. 6 shows a configuration in which the scanning selection transistor Tr1 explained based on FIG. 4 is eliminated, and a switching transistor Tr3 is newly added. This switching transistor Tr3 includes first and second controlled terminals which open and close between the terminals according to a switching signal input to the gate G which is a control terminal, that is, a well-known n-channel type TFT provided with a source S and a drain D.

The first controlled terminal (source S) of this first switching transistor Tr3 is connected to a connecting point of the EL element E1 and the light-emitting drive transistor Tr2, and a voltage source for a voltage V2 to supply the above-described second current is connected to the second terminal (drain D) of the switching transistor Tr3. Moreover, the potential of the voltage source for a voltage of V2 supplied to the drain of the switching transistor Tr3 is set lower than that of the voltage source for a voltage of V1 supplied to the source of the light-emitting drive transistor Tr2 in this embodiment.

According to the above-described configuration, a light-emitting drive current (first current) based on video signals is supplied to the EL element E1 when the switching transistor Tr3 is put into an OFF state, and the light-emitting drive transistor Tr2 is put into an ON state. Moreover, a current (second current) larger than the light-emitting drive current (first current) based on video signals is supplied from the voltage source for a voltage of V2 to the EL element E1 regardless of the state of the light-emitting drive transistor Tr2 when the switching transistor Tr3 is put into an ON state. Thereby, the EL element E1 is put into the first self-repairing mode which is a light-emitting state with higher brightness. The above-described first self-repairing mode can be used, as will be described later, to repair leaks of the first and second leak modes, or to effectively prevent the generation of the leaks.

FIG. 7 shows a sixth embodiment according to the present invention, and an example in which the invention is applied in an active drive type display panel is also shown in the drawing. Here, the embodiment shown in FIG. 7 is mainly based on the eighth aspect of the invention. And, the embodiment shown in FIG. 7 has a configuration in which a switch SW1 is provided as a switching unit in addition to the embodiment shown in FIG. 6.

The above-described switching switch SW1 has a configuration in which, in a similar manner to that of FIG. 6, the voltage of a power supply for a voltage of V2 by which a second current is supplied to an EL element E1 can be selected, and the voltage of a power supply for a voltage of V4 by which a reverse-bias voltage is supplied to the EL element E1 can be simultaneously selected. Here, relations V1>V2, and V3>V4 are met in the configuration shown in FIG. 7 when it is assumed that the voltage of a voltage source, which is supplied to the source of a light-emitting drive transistor Tr2 is V1, and the voltage of another voltage source, which is supplied to the side of the cathode of the EL element E1, is V3.

Accordingly, a light-emitting drive current (first current) based on video signals is supplied to the EL element E1 when a switching transist or Tr3 is put into an OFF state, and the light-emitting drive transistor Tr2 is put into an ON state in a state shown in FIG. 7. Moreover, the switching transistor Tr3 and the EL element E1 exist in series between the voltage source for a voltage V2 and that for a voltage of V3 when the light-emitting drive transistor Tr2 is put into an OFF state, and the switching transistor Tr3 is put into an ON state. Thereby, the above-described second current flows from the voltage source for a voltage of V2 through the drain D and the source S of the transistor Tr3 to the EL element E1, and the EL element E1 is put into the first self-repairing mode in which an image with brightness higher than that generated by the first current is displayed.

On the other hand, the EL element E1 and the switching transistor Tr3 exist in series between the voltage source for a voltage of V3 and that with a voltage of V4 when the above-described switch SW1 is stitched to the different side from that of the configuration shown in FIG. 7. At this time, a first controlled terminal in the switching transistor Tr3, that is, a terminal connected to the anode of the EL element E1 functions as a drain, and a second controlled terminal in the transistor Tr3, that is, a terminal to which the voltage source for a voltage of V4 is connected functions as a source to effectively apply a reverse-bias voltage to the EL element E1.

Therefore, according to the configuration shown in FIG. 7, the first self-repairing mode in which the second current is supplied to the EL element E1 can be selected in a similar manner to that of FIG. 6, and, at the same time, the reverse-bias voltage can be applied to the EL element E1. Thereby, leaks of the after-described first and second leak modes can be repaired, or the generation of the leaks can be effectively prevented.

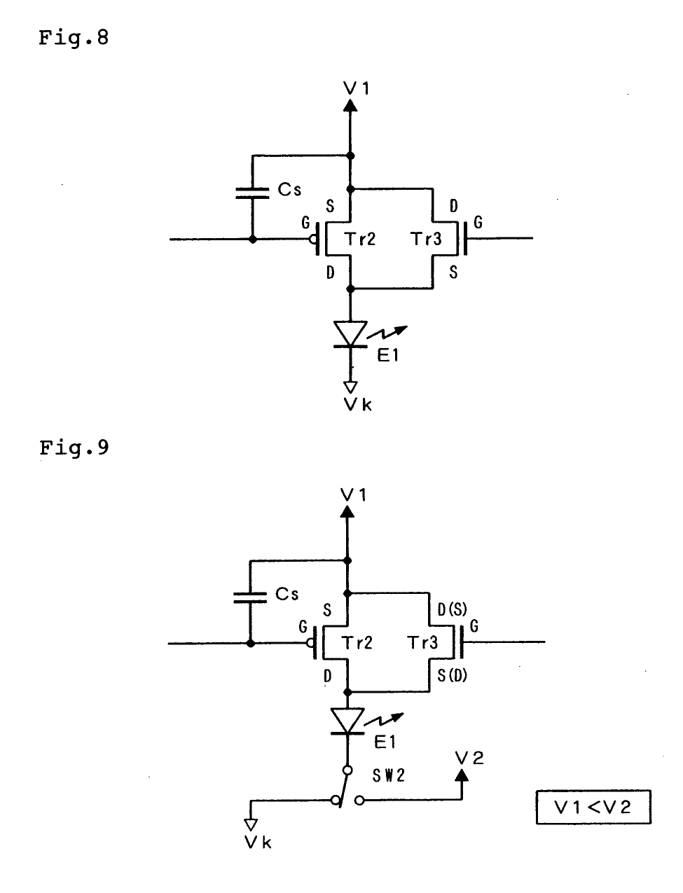

FIG. 8 shows a seventh embodiment according to the present invention, and an example in which the invention is applied in an active drive type display panel is also shown in the drawing. Here, the embodiment shown in FIG. 8 is mainly based on the ninth aspect of the invention. FIG. 8 also shows a configuration in which the scanning selection transistor Tr1 explained based on FIG. 4 is eliminated, and a switching transistor Tr3 is newly added.

This switching transistor Tr3 includes first and second controlled terminals which open and close between the terminals according to a switching signal input to a gate G which is a control terminal, that is, a well-known n-channel type TFT provided with a source S and a drain D. And, the source, which is the first controlled terminal of the above-described switching transistor, is connected to the drain of a light-emitting drive transistor Tr2, and the drain, which is the second controlled terminal of the above-described switching transistor, is connected to the source of the light-emitting drive transistor Tr2.

In the configuration shown in this FIG. 8, a light-emitting drive current (first current) based on video signals is supplied to the EL element E1 when the switching transistor Tr3 is put into an OFF state, and the light-emitting drive transistor Tr2 is put into an ON state. Moreover, a current (second current) larger than the light-emitting drive current (first current) based on video signals is supplied to the EL element E1 regardless of the state of the light-emitting drive transistor Tr2 when the switching transistor Tr3 is put into an ON state.

Thereby, the EL element E1 is put into the first self-repairing mode in which an image with brightness higher than that generated by the first current is displayed. The above-described first self-repairing mode can be used, as will be described later, to repair leaks of the first and second leak modes, or to effectively prevent the generation of the leaks.

FIG. 9 shows a eighth embodiment according to the present invention, and an example in which the invention is applied in an active drive type display panel is also shown in the drawing. Here, the embodiment shown in FIG. 9 is mainly based on the tenth aspect of the invention. FIG. 9 also shows a configuration in which the scanning selection transistor Tr1 explained based on FIG. 4 is eliminated, and a switching transistor Tr3 is newly added.

And, the embodiment shown in FIG. 9 has a configuration in which, in addition to that of FIG. 8, a switching switch SW2 is connected to the side of the cathode of the EL element E1, and the voltage of a voltage source for a voltage of V2 or that for a voltage of Vk can be selected through switching. And, a relation V1<V2 is met in the configuration shown in FIG. 9 when it is assumed that the voltage of a power supply, which is supplied to the source of a light-emitting drive transistor Tr2, is V1.

When the above-described switching switch SW2 is connected to the side of Vk in the configuration shown in FIG. 9, as shown in the drawing, the similar processing to that of the embodiment shown in FIG. 8 is realized. That is, a light-emitting drive current (first current) based on video signals is supplied to the EL element E1 when the switching transistor Tr3 is put into an OFF state, and the light-emitting drive transistor Tr2 is put into an ON state. Moreover, a current (second current) larger than the light-emitting drive current (first current) based on video signals is supplied to the EL element E1 regardless of the state of the light-emitting drive transistor Tr2 when the switching transistor Tr3 is put into an ON state.

On the other hand, the EL element E1 and the switching transistor Tr3 exist in series between the voltage source for a voltage of V2 and that for a voltage of V1 regardless of the state of the light-emitting drive transistor Tr2 when the above-described switch SW2 is connected to the different side from that shown in the drawing, that is, to the side of the voltage source for a voltage of V2, and the switching transistor Tr3 is put into an ON state, At this time, a first controlled terminal in the switching transistor Tr3, that is, a terminal connected to the anode of the EL element E1 functions as a drain, and a second controlled terminal in the transistor Tr3, that is, a terminal to which the voltage source for a voltage of V1 is connected functions as a source to effectively apply a reverse-bias voltage to the EL element E1.

Therefore, according to the configuration shown in FIG. 9, the first self-repairing mode can be selected to supply a second current to the EL elements E1 and the reverse-bias voltages can be simultaneously applied to the EL element E1, too. Thereby, leaks of the after-described first and second leak modes can be repaired, or the generation of the leaks can be effectively prevented.

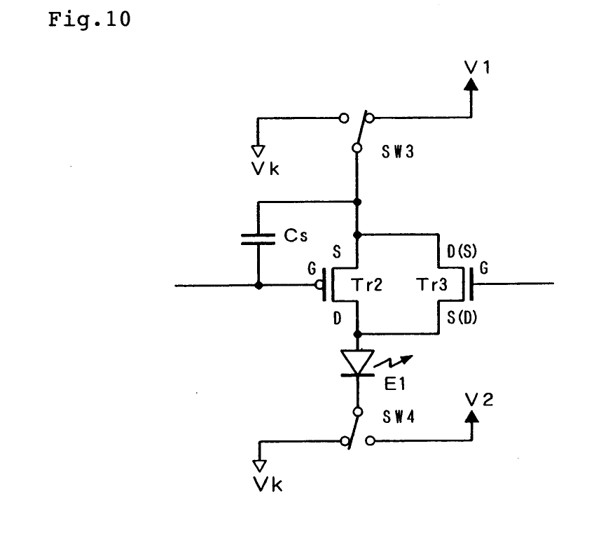

FIG. 10 shows a ninth embodiment according to the present invention, and an example in which the invention is applied in an active drive type display panel is also shown in the drawing. Here, the embodiment shown in FIG. 10 is mainly based on the eleventh aspect of the invention. FIG. 10 also shows a configuration in which the scanning selection transistor Tr1 explained based on FIG. 4 is eliminated, and a switching transistor Tr3 is newly added.

The embodiment shown in FIG. 10 has a configuration in which a power supply for a voltage of V1 to supply a second current in the forward direction to an EL element E1 can be connected through switching to the side of the source of a light-emitting drive transistor Tr2, and a power supply for a voltage of V2 to supply a reverse-bias voltage to the above-described EL element E1 can be connected through switching to the side of the cathode of the EL element E1 in the ON period of the switching transistor Tr3.

That is, a switching switch SW3 is configured to be provided at the source side of the light-emitting drive transistor Tr2 so that the voltage of the power supply for a voltage of V1 or the voltage of a power supply for a voltage of Vk can be selected. Moreover, a switching switch SW4 is also configured to be provided at the cathode side of the EL element E1 so that the side of the voltage of the power supply for a voltage of V2 or that of the power supply for a voltage of Vk can be selected.

The EL element E1 is put into a lighting state by a first current between the power supply for the voltage of V1 and that for the voltage of Vk when the switching transistor Tr3 is put into an OFF state, and the light-emitting drive transistor Tr2 is put into an ON state as shown in FIG. 10. Here, when the switching transistor Tr3 is put into an ON state, the above-described second current is supplied from the drain D of the switching transistor Tr3 to the EL element E1 through the source S of the transistor Tr3 regardless of the state of the light-emitting drive transistor Tr2 to realize the first self-repairing mode.

On the other hand, the EL element E1 and the switching transistor Tr3 exist in series between the voltage source for a voltage of V2 and that for a voltage of Vk regardless of the state of the light-emitting drive transistor Tr2 when each of the above-described switches SW3 and Sw4 is switched to the opposite direction from that of the configuration shown in FIG. 10, and, under this state, the switching transistor Tr3 is put into an ON state. At this time, a first controlled terminal in the switching transistor Tr3, that is, a terminal connected to the anode of the EL element E1 functions as a drain, and a second controlled terminal in the transistor Tr3, that is, a terminal to which the voltage source for a voltage of V1 is connected functions as a source to effectively apply a reverse-bias voltage to the EL element E1.

Accordingly, even in the configuration shown in FIG. 10, the first self-repairing mode can be selected to supply the second current to the EL elements E1 and the reverse-bias voltages can be simultaneously applied to the EL element E1, too. Thereby, leaks of the after-described first and second leak modes can be repaired, or the generation of the leaks can be effectively prevented.

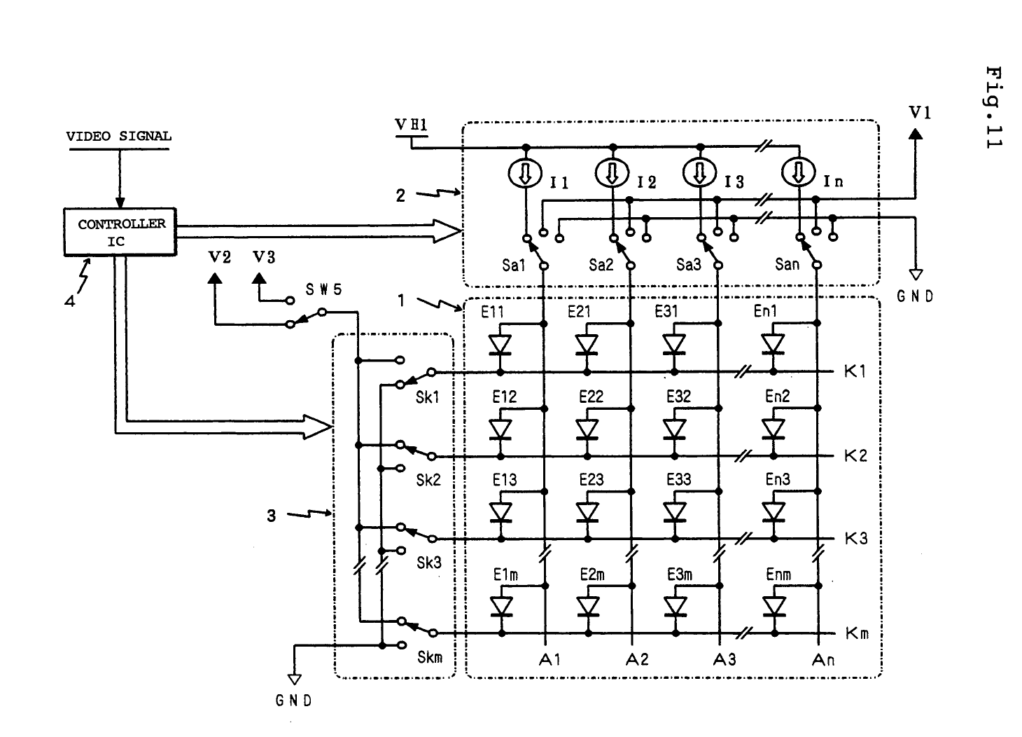

Then, FIG. 11 shows a tenth embodiment according to the present invention, and an example in which the invention is applied in an active drive type display panel is shown in the drawing. In FIG. 11, parts, which are similar to those previously explained in FIGS. 1 through 3 with regard to their functions, are denoted by the same reference numbers as those in FIGS. 1 through 3, and common detailed description will be eliminated. Here, the embodiment shown in FIG. 11 is mainly based on the twelfth and thirteenth aspects of the invention.

The embodiment shown in FIG. 11 has a configuration in which a first voltage as a reverse voltage and a second voltage as the reverse voltage larger than the first voltage can be independently applied to each of the EL elements E11 through Enm arranged on a display panel 1. That is, the embodiment shown in FIG. 11 has a configuration in which the voltage of a voltage source for a voltage of V2 or that of a voltage source for the voltage of V3 can be selected through a switching switch SW5, and potential by the voltage source selected through the this switch SW5 can be applied to the cathode of each of the EL elements E11 through Enm arranged on the display panel 1 through the corresponding one of scanning switches Sk1 through Skm in a cathode-line scanning circuit 3.

When the reverse-bias voltage is applied to each of the EL elements E11 through Enm, using either of the voltage source for a voltage of V2 or the voltage source for a voltage of V3, all of drive switches Sa1 through Sam in an anode-line drive circuit 2 are configured to be set at the ground GND. Here, the relation between the above-described voltage source for a voltage of V2 and that for a voltage of V3 with regard to the potential is configured to meet a relation of V2<V3. Accordingly, the above-described first reverse-bias voltage can be applied to each of the EL elements E11 through Enm when the switching switch SW5 selects theivoltage of the voltage source for a voltage of V2, and the above-described second reverse-bias voltage larger than the first reverse-bias voltage can be applied to each of the EL elements E11 through Enm when the switch SW5 selects the voltage of the voltage source for a voltage of V3.

Here, the embodiment shown in FIG. 11 has a configuration in which the voltage of a constant voltage source for a voltage of V1 is supplied to the anode line drive circuit 2, as explained based on FIG. 2, to supply a second current to the EL elements E11 through Enm. Accordingly, when a relation among the potential of the above-described voltage sources meets a relation of V1<V2<V3, the first reverse-bias voltage can be applied to each of the EL elements E11 through Enm by a combination between the voltages V2 and V3, and the second reverse-bias voltage can be applied to each of the EL elements E11 through Enm by a combination between the voltages V1 and V3.

In order to apply the first or second reverse-bias voltage to each of the EL elements, it is preferable to set a all-lights out period, during which lights-out of all the EL elements E11 through Enm is executed, in one frame period or in one sub-frame period, and to apply the above-described first or second reverse-bias voltage to each of the EL elements E11 through Enm in the above-described period. Application of a reverse-bias voltage to EL elements E11 through Enm in the above-described manner can contribute to promotion of self-repairing of the EL elements as already explained. Here, assuming that a mode in which a reverse-bias voltage is applied to each of the EL elements as described above is called a second self-repairing mode, the above-described second self-repairing mode can be used, as will be described later, to repair leaks of the first and second leak modes, or to effectively prevent the generation of the leaks.

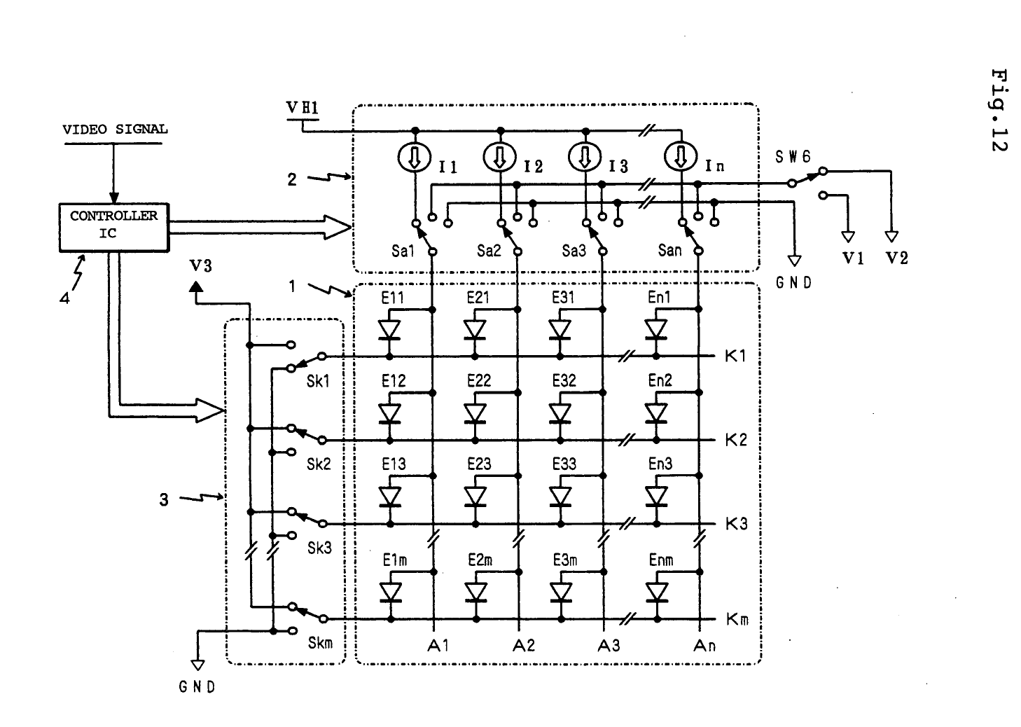

FIG. 12 shows an eleventh embodiment according to the present invention, and an example in which the invention is applied in the passive matrix type display panel and the driving circuitry is also shown in the drawing. In FIG. 12, parts, which are similar to those previously explained in FIGS. 1 through 3 with regard to their functions, are denoted by the same reference numbers as those in FIGS. 1 through 3, and common detailed description will be eliminated. Here, the embodiment shown in FIG. 12 is mainly based on the eleventh aspect of the invention.

The embodiment shown in FIG. 12 has a feature that a reverse-bias voltage caused by a first voltage, or a reverse-bias voltage caused by a second voltage can be applied to each of EL elements by switching between constant voltage sources at the anode side of the EL element. That is, the embodiment shown in FIG. 12 has a configuration in which the voltage of a voltage source for a voltage of V1, or that of a voltage source for a voltage of V2 can be selectively supplied to an anode-line drive circuit 2 through a switching switch SW6. Moreover, potential from a voltage source for a voltage of V3 is supplied to a cathode-line scanning circuit 3, and a relation among potential of the voltage sources is set so that a relation of V3>V2>V1 is met.

A first reverse-bias voltage of a difference in the potential between the above-described V3 and V2 is applied to each of EL elements E11 through Enm in the above-described configuration when all of scanning switches Sk1 through Skm in the cathode-line scanning circuit 3 are connected to the voltage source for a voltage of V3; all of drive switches Sa1 through Sam in the anode-line drive circuit 2 are connected to the side of the switching switch SW6; and the switching switch SW6 selects the voltage of the voltage source for a voltage of V2 as shown in FIG. 12. And, when the switching switch SW6 selects the voltage of the voltage source for a voltage of V1 in a different manner from that of FIG. 12, a second reverse-bias voltage of a difference in the potential between the above-described V3 and V1 is applied to each of EL elements E11 through Enm.

In order to apply the first or second reverse-bias voltage to each of the EL elements, it is preferable to set a all-lights out period, during which lights-out of all the EL elements E11 through Enm is executed, in one frame period or in one sub-frame period, and to apply the above-described first or second reverse-bias voltage to each of the EL elements E11 through Enm. Application of a reverse-bias voltage to EL elements E11 through Enm in the above-described manner can contribute to promotion of self-repairing of the EL elements as already explained. And, assuming that a mode in which a reverse-bias voltage is applied to each of the EL elements as described above is also called a second self-repairing mode, the above-described second self-repairing mode can be used, as will be described later, to repair leaks of the first and second leak modes, or to effectively prevent the generation of the leaks.

Here, in the embodiments shown in FIGS. 11 and 12, a reverse-bias voltage by the second voltage with a level higher than that of the first voltage is preferably applied when a reverse-bias voltage by the first voltage is applied a predetermined times. As described above, when a reverse-bias voltage by the second voltage with a higher level is intermittently applied, a comparatively large current flows on a location in which a phenomenon like a leak is caused in the electrode or the light-emitting layer of the EL element, and the EL element with the above-described phenomenon can be quickly rehabilitated.

It is also effective to execute the above processing at time of aging which is executed at the start of manufacturing, and, in the case of an electronic device mounted with the above-described light-emitting module, effective self-repairing can be realized by executing the above processing under supply of electric power every one frame or one sub-frame when leak according to the above-described second leak mode is generated in an EL element.

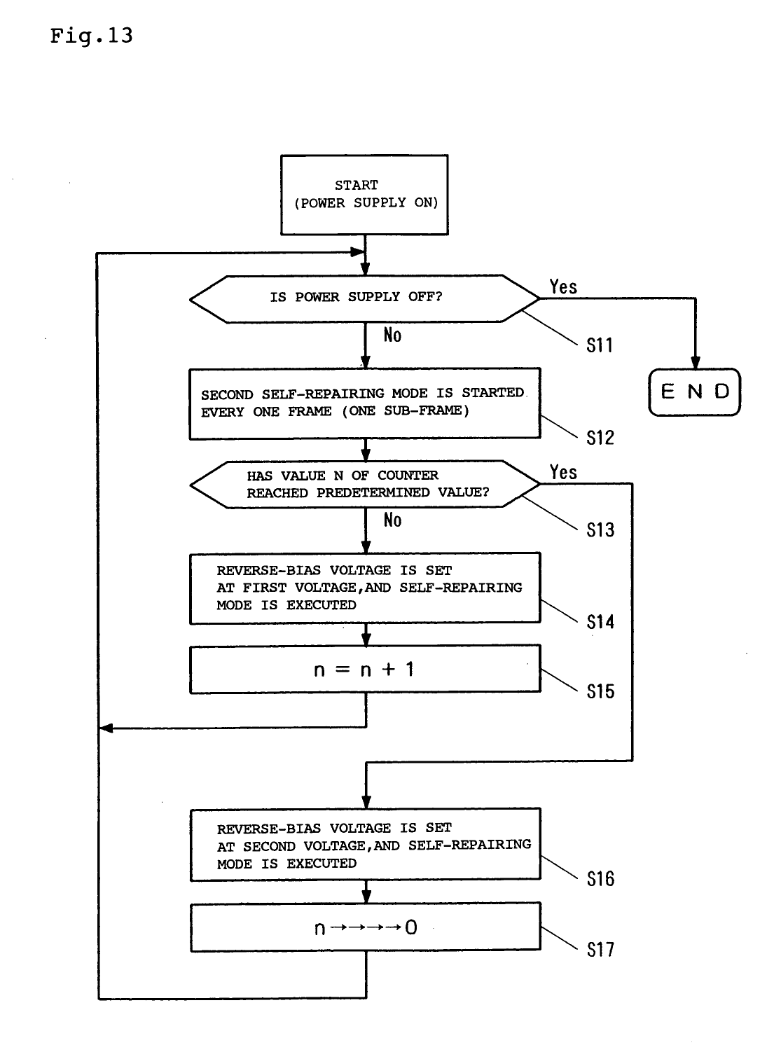

FIG. 13 shows one example of a preferable operation flow when the above-described second self-repairing mode is executed. This operation flow starts when an operation power supply is ON. As shown in FIG. 13, it is monitored at STEP S11 whether the power supply is OFF or not, and execution of this operation flow is stopped when the power supply is OFF. In a state in which the power supply is ON, the above-described second self-repairing mode is started every one frame or one sub-frame at STEP S12.

In this case, a counter which is incremented every time the second self-repairing mode is executed is provided as will be explained later, and it is judged at STEP S13 whether the value n of the above-described counter reaches a predetermined value or not. When it is judged that the counter does not reach the predetermined value, the self-repairing mode is executed at STEP S14, setting a reverse-bias voltage at a first voltage. That is, the self-repairing mode is executed in the embodiment shown in FIG. 11 by selecting the voltage of the voltage source for a voltage of V2 through the switching switch SW5 and the mode is done in a similar manner to FIG. 11 in the embodiment shown in FIG. 12 by selecting the voltage of V2 through the switching switch SW6. Thereby, the self-repairing modes by the above-described first voltage are executed.

Subsequently, the value n of the above-described counter is incremented at STEP S15, and the processing proceeds to STEP S11. When the above-described operations at STEP S11 through STEP S15 are repeated a predetermined times, it is judged at STEP S13 that the value n of the above-described counter has reached the predetermined value. In this case, the processing proceeds to STEP S16, at which the self-repairing mode is executed, setting a reverse-bias voltage at a second voltage value.

That is, the switching switch SW5 selects the voltage of the voltage source for a voltage of V3 in the embodiment shown in FIG. 11 to execute the self-repairing mode, and the switching switch SW6 selects the voltage of the voltage source for a voltage of V1 in the embodiment shown in FIG. 12 to execute the self-repairing mode. Thereby, the self-repairing modes by a higher reverse-bias voltage are executed. The value n of the above-described counter is reset to zero at STEP S17 after STEP S16 is executed, and a routine by which the processing returns to STEP S11 again is executed. Thereby, a routine by which the self-repairing mode by the second reverse-bias voltage is executed after the self-repairing mode by the first reverse-bias voltage is executed a predetermined times is repeated.

Incidentally, when the above-described second self-repairing mode is executed, it has been confirmed that it is more effective for execution of the self-repairing to control so that a period during which a reverse-bias voltage is applied to an EL element is made longer. However, it is required for execution of the second self-repairing mode to control all of the EL elements so that the EL elements are put into a non-lighting state at the same time. For example, the rate of the lighting time of the EL elements is reduced when time during which all of the EL elements is controlled to be put into a non-lighting state is made longer for one frame period or for one sub-frame period.

Then, when an electronic device mounted with the above-described display panel is in an unused state, it is preferable to set a mode in which the non-lighting scanning period is made longer than that of the usual lighting time, and a reverse-bias voltage is applied to the above-described light-emitting elements during this non-lighting scanning period. The mode in which the non-lighting scanning period is set longer than that of the usual lighting time, and a reverse-bias voltage is applied to the light-emitting elements during this non-lighting scanning period as described above is called a third self-repairing mode in the present description.

The first through third self-repairing modes which have been explained above can be selectively executed at aging after the display panel is manufactured. Thereby, it is possible to effectively realize the self-repairing of a leak of the first leak mode which has existed from the start of manufacturing, as already explained. Moreover, the above-described first through third self-repairing modes can be effectively used for a leak of the above-described second mode, which is generated after an electronic device mounted with the above-described display panel is delivered to a user, and effective self-repairing of the leak can be realized.

Especially, when repairing of a leak of the second mode generated, as described in the latter case, after an electronic device mounted with the display panel is delivered to a user, is executed, the self-repairing modes are executed when the electronic device is in an unused state, according to a preferable configuration. In this case, in an electronic device, such as a cellular telephone and a personal digital assistance (PDA), for which a rechargeable battery is used, the above-described first through third self-repairing modes can be selectively executed when the above-described battery is under recharging.

During such recharging, a few of users have an opportunity of monitoring the display panel, and consumed electric power can be secured enough for execution of the first through third self-repairing modes. Moreover, it is preferable that an electronic device, such as a cellular telephone and a personal digital assistance, in which the surface of the display panel is closed in a folded state, has a configuration in which the above-described first through third self-repairing mode are selectively executed after the folded state is detected.

Though the first through third self-repairing modes are effective in consideration that self-repairing of a leak is realized, or a leak is prevented beforehand according to the modes, a problem that the light-emitting life of the EL element is remarkably reduced when the above-described modes are selectively executed at any time in an unused state of the electronic device has occurred. Then, according to a preferable configuration, the above-described first through third self-repairing modes are executed on a regular basis, using a timer mounted in the above-described electronic device.

In this case, the above-described first through third self-repairing modes are preferably configured to be executed when it is detected with the timer that a predetermined time has elapsed since the last self-repairing was executed, and, furthermore, that the battery is being recharged, or the surface of the display panel is closed.

Here, it is preferable in the case of the above-described personal digital assistance that execution of any one of the above-described self-repairing modes is configured to be prohibited when the amount of remaining power in the battery is detected to be equal to or lower than a predetermined one. The reason is that it is preferable to execute the self-repairing modes in a state in which the sufficient amount of remaining power is left in the battery, because power consumption is large when the self-repairing modes are executed.

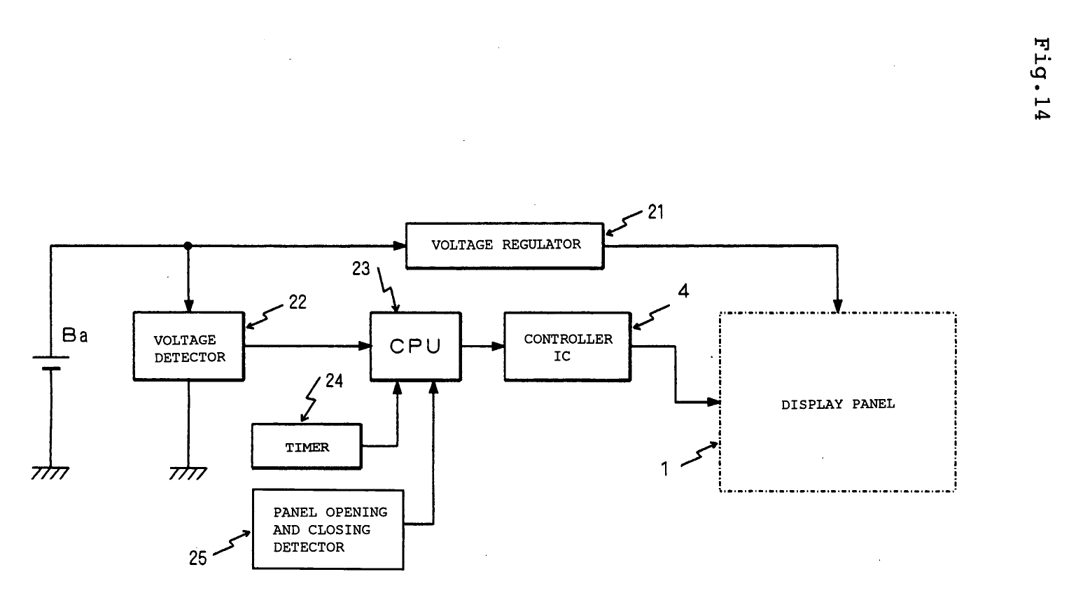

FIG. 14 shows an example of a configuration for the above-described operations, and the example is adopted for the above-described cellular telephone or personal digital assistance. A current from a battery Ba is supplied to a voltage regulator 21 which step-ups the current, and a display panel 1 is driven for light-emitting according to the output voltage of the voltage regulator 21. The configuration shown in FIG. 14 has a configuration in which a voltage detector 22 which detects the amount of remaining power in the above-described battery Ba is provided, and the output of the voltage detector 22 is supplied to an arithmetic circuitry 23 including a CPU. Here, the voltage detector 22 has a configuration in which an “H” output (output with a high level) is supplied to the arithmetic circuitry 23 when it is judged that the percentage of the remaining power in the above-described battery Ba is, for example, 30% to 40% or more.

The output of a timer 24, and that of an panel opening and closing detector 25 are configured to be supplied to the above-described arithmetic circuitry 23. The above-described timer 24 has a configuration in which an “H” output is similarly supplied to the arithmetic circuitry 23 when the predetermined time has elapsed since the last self-repairing was executed. And, the panel opening and closing detector 25 has a configuration in which an “H” output is similarly supplied to the arithmetic circuitry 23 when the surface of the display panel is closed.

The above-described arithmetic circuitry 23 has a function by which it is judged, based on the output of the voltage detector 22, that of the timer 24, and that of the panel opening and closing detector 25, whether the above-described first through third self-repairing modes are executed or not. When the self-repairing is executed, an instruction is sent from the arithmetic circuitry 23 to the controller IC 4, and the first through third self-repairing modes are executed, based on the instruction.

In the above-described configuration, the arithmetic circuitry 23 functions so that execution of the self-repairing modes is prohibited when it is detected that the output of the voltage detector 22 is not enough, that is, that the output is not an “H” output. Moreover, execution of the self-repairing modes is similarly configured to be prohibited when it is detected that the output of the panel opening and closing detector 25 is not an “H” output. In conclusion, the preferable arithmetic circuitry 23 has a configuration in which an instruction is sent to the controller IC4 when all of the output of the above-described voltage detector 22, that of the timer 24, and that of the panel opening and closing detector 25 are an “H” output together, and the first through third self-repairing modes are executed, based on the instruction.

Though examples in which the present invention is applied to a personal digital assistance such as a cellular telephone have been explained above, the above-described self-repairing modes according to the invention can be executed for an electronic device such as a stationary or desktop display unit used for a personal computer, and a television receiver. In such a device, the above-described first self-repairing mode can be executed, for example, by displaying an image like a screen saver just after power-off with a power supply switch. Moreover, the above-described second self-repairing mode can be executed under lights-out of all EL elements, following execution of the first self-repairing mode after power-off with the power supply switch.

Here, though a conductance controlled configuration has been explained as one example for a pixel configuration of an active drive type, which is shown in FIGS. 4 through 10, the present invention is similarly applied to other types of pixel configurations in which an EL elements are connected in series to a light-emitting drive transistor, and are driven for light-emitting, that is, to pixel configurations of, for example, a current-mirror drive method, a current-programming drive method, a voltage-programming drive method, a threshold-voltage correction drive method and the like.

Moreover, other types of self-light-emitting elements with a diode characteristic can be also used as a self-light-emitting element, though examples in which an organic EL element is used as a self-light-emitting element arranged on a display panel have been illustrated in the embodiments explained above.

1. A drive unit for a light-emitting display panel with a pixel configuration including at least a plurality of scanning lines and a plurality of data lines which are intersecting with each other, and self-light-emitting elements with a diode characteristic, each of which is arranged at each intersecting point of each of the scanning lines and each of the data lines, having a configuration in which
a first current can be supplied from the side of the anode terminal in each self-light-emitting element concerned, and a second current larger than the first current can be supplied to the self-light-emitting element in order to drive the self-light-emitting element for lighting.

2. The drive unit for a light-emitting display panel according to claim 1, having a configuration in which
the first current is supplied from a constant current source through a switching unit, and the second current is supplied from another constant current source through another switching unit.

3. The drive unit for a light-emitting display panel according to claim 1, having a configuration in which
the first and second currents are supplied from one constant current source which can change the value of a current.

4. The drive unit for a light-emitting display panel according to claim 1, having a configuration in which
the first current is supplied from a constant current source, and the second current is supplied from a constant voltage source.

5. The drive unit for a light-emitting display panel according to claim 1, wherein
a power supply by which a reverse-bias voltage can be applied to the self-light-emitting element is further provided at either of the side of the anode terminal, or that of the cathode terminal or both of the sides of the self-light-emitting element.

6. The drive unit for a light-emitting display panel according to claim 1, having a configuration in which
the self-light-emitting element is connected in series to a light-emitting drive transistor to form a pixel, and the first current, or the second current can be selectively supplied to the self-light-emitting element according to different levels of gate potential applied to the light-emitting drive transistor.

7. The drive unit for a light-emitting display panel according to claim 1, wherein
the self-light-emitting element is connected in series to a light-emitting drive transistor to form a pixel, and a switching transistor including first and second controlled terminals which open and close between the terminals according to a switching signal input to a control terminal is provided,
the first controlled terminal of the switching transistor is connected to a connecting point of the self-light-emitting element and a light-emitting drive transistor, and a power supply to supply the second current is connected to the second controlled terminal of the switching transistor, and
the first current is supplied to the self-light-emitting element in the OFF period of the switching transistor, and the second current is supplied to the self-light-emitting element in the ON period of the switching transistor.

8. The drive unit for a light-emitting display panel according to claim 7, wherein
a power supply to supply the second current in the forward direction to the self-light-emitting element, and a power supply to supply a reverse-bias voltage to the self-light-emitting element can be selectively connected through switching to the second controlled terminal of the switching transistor.

9. The drive unit for a light-emitting display panel according to claim 1, wherein
the self-light-emitting element is connected in series to a light-emitting drive transistor to form a pixel, and a switching transistor including first and second controlled terminals which open and close between the terminals according to a switching signal input to a control terminal is provided,
the first and second controlled terminals of the switching transistor are connected between the source and the drain of the light-emitting drive transistor, and
the first current is supplied to the self-light-emitting element during the OFF period of the switching transistor, and the second current is supplied to the self-light-emitting element during the ON period of the switching transistor

10. The drive unit for a light-emitting display panel according to claim 9, wherein
a power supply to supply the second current in the forward direction to the self-light-emitting element, and a power supply to supply a reverse-bias voltage to the self-light-emitting element can be selectively connected through switching to the side of the cathode of the self-light-emitting element during the ON period of the switching transistor.

11. The drive unit for a light-emitting display panel according to claim 9, wherein
a power supply to supply the second current in the forward direction to the self-light-emitting element, and a power supply to supply a reverse-bias voltage to the self-light-emitting element can be selectively connected through switching to the side of the source of the light-emitting drive element, and the former power supply and the latter power supply can be selectively connected through switching to the side of the cathode of the self-light-emitting element during the ON period of the switching transistor.

12. A drive unit for a light-emitting display panel which has a pixel configuration including at least a plurality of scanning lines and a plurality of data lines which are intersecting with each other, and self-light-emitting elements with a diode characteristic, each of which is arranged at each intersecting point of each of the scanning lines and each of the data lines, and has a configuration in which, in order to drive the self-light-emitting element for lighting, a reverse-bias voltage in the backward direction, which is opposed to the forward direction, can be applied to the self-light-emitting element, wherein
the reverse-bias voltage has a first voltage and a second voltage larger than the first voltage.

13. The drive unit for a light-emitting display panel according to claim 12, having a configuration in which
a reverse-bias voltage by the first voltage, and a reverse-bias voltage by the second voltage can be applied to each of self-sight-emitting elements by switching between constant voltage sources at the side of the cathode of each of the self-light-emitting elements.

14. The drive unit for a light-emitting display panel according to claim 12, having a configuration in which
a reverse-bias voltage by the first voltage, and a reverse-bias voltage by the second voltage can be selectively applied to each of self-sight-emitting elements by switching between constant voltage sources at the side of the anode of each of the self-light-emitting elements.

15. The drive unit for a light-emitting display panel according to claim 12, having a configuration in which
a reverse-bias voltage by the first voltage is applied to each of the self-light-emitting elements, and, simultaneously, a reverse-bias voltage by the second voltage is applied to each of the elements every time the reverse voltage by the first voltage is applied to each of the elements a predetermined times.

16. The drive unit for a light-emitting display panel according to claim 1, wherein
a first self-repairing mode in which a current flowing in each of the self-light-emitting elements is a second current is provided.

17. The drive unit for a light-emitting display panel according to claim 16, having a configuration in which
all of the self-light-emitting elements arranged on the light-emitting display panel are controlled for lighting in the first self-repairing mode.

18. The drive unit for a light-emitting display panel according to claim 12, wherein
a second self-repairing mode in which a reverse-bias voltage applied to each of the self-light-emitting elements is the second voltage is provided.

19. The drive unit for a light-emitting display panel according to claim 18, having a configuration in which
all of the self-light-emitting elements arranged on the light-emitting display panel are controlled for lights-out in the second self-repairing mode.

20. The drive unit for a light-emitting display panel according to claim 12, wherein
a non-lighting scanning period longer than that of the usual lighting time is set during one frame period or one sub-frame period, and a third self-repairing mode in which a reverse-bias voltage is applied to each of the self-light-emitting elements during the non-lighting scanning period is provided.

21. The drive unit for a light-emitting display panel according to claim 1 or claim 12, wherein
each of the self-light-emitting element is an organic EL element using an organic compound for a light-emitting layer.

22. An electronic device mounted with the light-emitting display panel and the drive unit therefor according to any one of claim 16, claim 18, claim 20, wherein
a timer is mounted in the electronic device, and any one of the first self-repairing mode, the second self-repairing mode, the third self-repairing mode is executed according to the accumulated time of the timer.

23. The electronic device, which uses a rechargeable battery, according to claim 22, wherein
Any one of the first self-repairing mode, the second self-repairing mode, the third self-repairing mode is executed during the charging operation of the battery.

24. The electronic device, in which visibility of the surface of the display panel is configured to be lost by closing the light-emitting display panel, according to claim 22, wherein any one of the first self-repairing mode, the second self-repairing mode, the third self-repairing mode is executed in a state in which the light-emitting display panel is closed.

25. The electronic device, which is operated by a battery, according to claim 22, having a configuration in which
execution of any one of the first self-repairing mode, the second self-repairing mode, the third self-repairing mode is prohibited when the amount of remaining power in the battery is detected to be equal to or lower than a predetermined one.
